(19) United States
(12) Patent Application Publication
(10) Pub. No.: US 2003/0094378 A1
(43) Pub. Date: May 22, 2003

(54) Electrochemical cell pressure regulating system and methods of using the same

(76) Inventor: Jason Shiepe, Middletown, CT (US)

Correspondence Address: CANTOR COLBURN, LLP, 55 GRIFFIN ROAD SOUTH, BLOOMFIELD, CT, 06002

(21) Appl. No.: 10/065,577

(22) Filed: Oct. 31, 2002

Related U.S. Application Data
(60) Provisional application No. 60/332,320, filed on Nov. 16, 2001.

(51) Int. Cl. C02F 1/46

(52) U.S. Cl. 205/335; 205/637; 204/263; 204/266

(57) ABSTRACT

Disclosed herein are electrochemical cell systems, pressure control systems, and methods for operating those systems. In one embodiment, the electrochemical cell system comprises: an electrochemical cell stack; a phase separation apparatus in fluid communication with the electrochemical cell stack; a water discharge in fluid communication with the phase separation apparatus; a first flow control device and a second flow control device disposed in fluid communication between the phase separation apparatus and water discharge; and a control device in operable communication with a sensor, the first flow control device, and the second flow control device. In one embodiment, the pressure regulating system comprises: means for generating hydrogen; means for sensing a liquid level within a phase separation apparatus disposed in fluid communication with the means for generating. hydrogen; means for regulating the liquid level within the phase separation apparatus disposed in operable communication with the phase separation apparatus; and means for maintaining a system pressure in the hydrogen gas generator system within a selected range upon release of liquid from the phase separation apparatus.

### CROSS REFERENCE TO RELATED APPLICATIONS

The present application claims priority to Provisional Patent Application Serial No. 60/332,320 filed on Nov. 16, 2001, which is incorporated herein by reference, in its entirety.

### BACKGROUND OF INVENTION

Electrochemical cells are energy conversion devices, usually classified as either electrolysis cells or fuel cells. A proton exchange membrane electrolysis cell functions as a hydrogen generator by electrolytically decomposing water to produce hydrogen and oxygen gases, and functions as a fuel cell by electrochemically reacting hydrogen to generate electricity. Referring to FIG. 1, which is a partial section of a typical anode feed electrolysis cell 100, process water 102 is fed into cell 100 on the side of an oxygen electrode (anode) 116 to form oxygen gas 104, electrons, and hydrogen ions (protons) 106. The reaction is facilitated by the positive terminal of a power source 120 electrically connected to anode 116 and the negative terminal of power source 120 connected to a hydrogen electrode (cathode) 114. The oxygen gas 104 and a portion of the process water 108 exits cell 100, while protons 106 and water 110 migrate across a proton exchange membrane 118 to cathode 114 where hydrogen gas 112 is formed.

Another typical water electrolysis cell using the same configuration as depicted in FIG. 1 is a cathode feed cell (not shown), wherein process water is fed on the side of the hydrogen electrode. A portion of the water migrates from the cathode across the membrane to the anode where hydrogen ions and oxygen gas are formed due to the reaction facilitated by connection with a power source across the anode and cathode. A portion of the process water exits the cell at the cathode side without passing through the membrane.

A typical fuel cell uses the same general configuration as is shown in FIG. 1. Hydrogen gas is introduced to the hydrogen electrode (the anode in fuel cells), while oxygen or an oxygen-containing gas such as air, is introduced to the oxygen electrode (the cathode in fuel cells). In some fuel cells water is also introduced with the feed gas. The hydrogen gas for fuel cell operation can originate from a pure hydrogen source, methanol or other hydrogen source. Hydrogen gas electrochemically reacts at the anode to produce protons and electrons, wherein the electrons flow from the anode through an electrically connected external load, and the protons migrate through the membrane to the cathode. At the cathode, the protons and electrons react with the oxygen gas to form resultant water, which additionally includes any feed water that is dragged through the membrane to the cathode. The electrical potential across the anode and the cathode can be exploited to power an external load.

In certain arrangements, the electrochemical cells can be employed to both convert electricity into hydrogen, and hydrogen back into electricity as needed. Such systems are commonly referred to as regenerative fuel cell systems.

### TECHNICAL FIELD

The present disclosure relates to electrochemical cell systems and especially relates to pressure regulating in electrochemical cell systems.

### SUMMARY OF INVENTION

Disclosed herein are electrochemical cell systems, pressure control systems, methods for operating those systems, and computers and computer data signals associated therewith. In one embodiment, the electrochemical cell system comprises: an electrochemical cell stack; a phase separation apparatus in fluid communication with the electrochemical cell stack; a water discharge in fluid communication with the phase separation apparatus; a first flow control device and a second flow control device disposed in fluid communication between the phase separation apparatus and water discharge; and a control device in operable communication with a sensor, the first flow control device, and the second flow control device.

In one embodiment, the pressure regulating system comprises: means for generating hydrogen; means for sensing a liquid level within a phase separation apparatus disposed in fluid communication with the means for generating hydrogen; means for regulating the liquid level within the phase separation apparatus disposed in operable communication with the phase separation apparatus; and means for maintaining a system pressure in the hydrogen gas generator system within a selected range upon release of liquid from the phase separation apparatus.

In one embodiment, the method for regulating pressure comprises: directing a fluid stream from an electrolysis cell to a hydrogen/water phase separation apparatus; sensing a liquid level within the hydrogen/water phase separation apparatus; regulating the liquid level within the hydrogen/water phase separation apparatus by at least one of introducing and releasing liquid from the hydrogen/water phase separation apparatus based upon the liquid level; monitoring electrolysis cell system pressure; regulating electrolysis cell system pressure with a first flow control device and a second flow control device disposed in fluid communication between the hydrogen/water phase separation apparatus and a water discharge, and in operable communication with a control device; and maintaining the electrolysis cell system pressure within a selected range.

In one embodiment, the computer data signal comprises: instructions for causing a computer to implement a method for operating a power system, the method comprising: sensing a liquid level within a hydrogen/water phase separation apparatus; regulating the liquid level within the hydrogen/water phase separation apparatus by at least one of introducing and releasing liquid from the hydrogen/water phase separation apparatus based upon the liquid level; monitoring electrolysis cell system pressure; regulating electrolysis cell system pressure with a first flow control device and a second flow control device disposed in fluid communication between the hydrogen/water phase separation apparatus and a water discharge, and in operable communication with a control device; and maintaining the electrolysis cell system pressure within a selected range.

The above described and other features are exemplified by the following figures and detailed description.

### BRIEF DESCRIPTION OF DRAWINGS

Referring now to the drawings, which are meant to be exemplary and not limiting, and wherein like elements are numbered alike in the several Figures:

FIG. 1 is a schematic diagram of a prior art electrolysis cell showing an electrochemical reaction;

FIG. 2 is a schematic representation of an exemplary embodiment of an electrolysis cell system incorporating a proton exchange membrane electrolysis cell;

FIG. 3 is partial, exploded schematic, more detailed representation of area 3 in FIG. 2 of the hydrogen/water separation apparatus in operable communication with a proton exchange membrane electrolysis cell, a hydrogen separator, and a pressure regulating system;

FIG. 4 is a partial, exploded, alternative, more detailed schematic representation of area 3 in FIG. 2 of the hydrogen/water separation apparatus in operable communication with a proton exchange membrane electrolysis cell, a hydrogen separator, and a pressure regulating system;

FIG. 5 is a partial, exploded, alternative, more detailed schematic representation of area 3 in FIG. 2 of the hydrogen/water separation apparatus in operable communication with a proton exchange membrane electrolysis cell, hydrogen separator and a pressure regulating system;

FIG. 6 is a partial exploded schematic, more detailed representation of area 6 in FIG. 2 depicting the hydrogen/water separation apparatus in operable communication with a proton exchange membrane cell, hydrogen separator, water discharge, and a pressure regulating system;

FIG. 7 is a partial exploded alternative, more detailed schematic representation of area 3 in FIG. 2 depicting the hydrogen/water separation apparatus in operable communication with a proton exchange membrane cell, hydrogen separator, water discharge, and a pressure regulating system;

FIG. 8 is a partial exploded, alternative, more detailed schematic representation of area 3 in FIG. 2 depicting the hydrogen/water separation apparatus in operable communication with a proton exchange membrane cell, hydrogen separator, water discharge, and a pressure regulating system; and

FIG. 9 is an exemplary alternative embodiment of the schematic representation of FIG. 2 depicting an alternative embodiment of the pressure regulating system in operable communication with the hydrogen/water separation apparatus and water discharge.

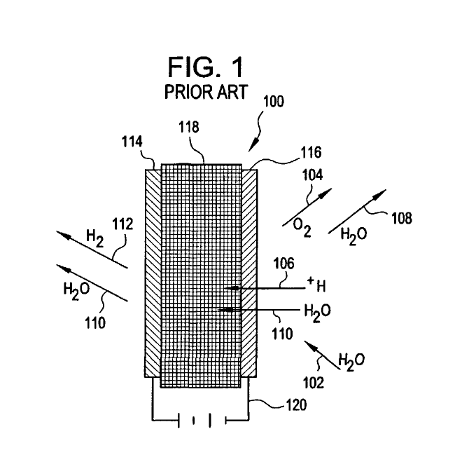

### DETAILED DESCRIPTION

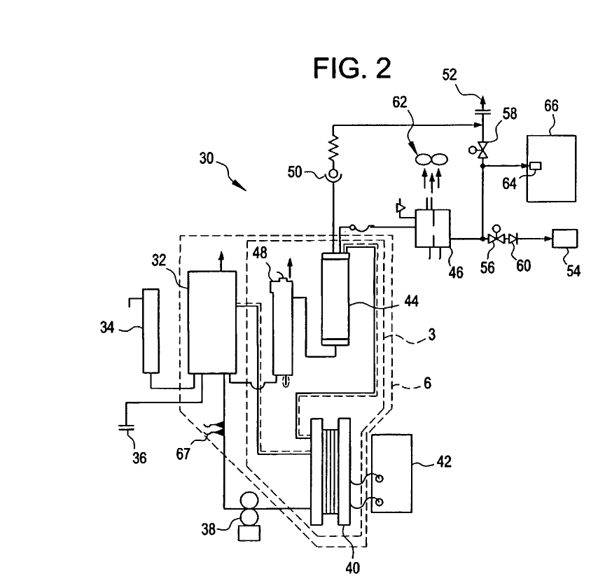

Referring generally to FIG. 2, an electrolysis cell system incorporating a proton exchange membrane electrolysis cell is shown generally at 30 and is hereinafter referred to as “system 30.” System 30 is suitable for generating hydrogen for various uses, e.g., in gas chromatography, as a fuel source (e.g., for a vehicle, in a fuel cell, and the like), and for various other applications. Furthermore, although the description and figures are directed to the production of hydrogen and oxygen gas by the electrolysis of water, the apparatus is applicable to the generation of other gases from other reactant materials.

System 30 includes a water-fed electrolysis cell capable of generating gas from reactant water and is operatively connected to a control system. Reactant water, which is preferably deionized, distilled water, may be continuously supplied from a water discharge 32 having a level indicator 34 and a drain 36 operatively included therewith. The reactant water is pumped via a supply line through a pump 38 into an electrolysis cell 40. The supply line is preferably clear unplasticized polyvinyl chloride (PVC) hose. An electrical conductivity sensor 67 may be disposed within the supply line to monitor the electrical potential of the reactant water, thereby determining its purity and ensuring its adequacy for use in the system 30.

Electrolysis cell 40 comprises a plurality of cells encapsulated within sealed structures (not shown). Manifolds and/or other types of conduits (not shown) that are in fluid communication with the cell components receive reactant water. An electrical charge applied across the anodes and cathodes of each cell within electrolysis cell 40 provided by a power supply 42 electrolyze the water and form oxygen and hydrogen streams. Oxygen and water exit the electrolysis cell 40 via a common stream, and may ultimately be returned to water discharge 32, where the water is recycled and the oxygen is optionally vented to the atmosphere or stored. The hydrogen stream, which contains water, exits electrolysis cell 40 and is fed into a hydrogen/water phase separation apparatus shown generally at 44 (hereinafter “separator 44”).

Separator 44 may also include a release 50, which may be a relief valve or the like, to rapidly purge hydrogen from the separator 44 to a hydrogen vent 52 when the pressure or pressure differential exceeds a selected limit. The hydrogen stream is fed into the separator 44 at a pressure of less than about one pound per square inch (psi) (6,897 pascals (Pa)), to greater than about 20,000 psi (1.34×10⁸ Pa), and even greater than about 30,000 psi (2.07×10⁸ Pa). Preferably, within this range, the pressure is greater than or equal to about one psi (6,897 Pa), with greater than or equal to about 2,000 psi (1.34×10⁷ Pa) more preferred and greater than or equal to about 2,500 psi (1.72×10⁷ Pa) even more preferred. Also preferred in this range is a pressure of less than or equal to about 10,000 psi (6.90×10⁷ Pa) with a pressure of less than or equal to about 6,000 psi (4.14×10⁷ Pa) more preferred. Some water is removed from the hydrogen stream at separator 44. This drier hydrogen stream is further dried at a diffuser 46, and the removed water (usually with trace amounts of hydrogen entrained therein) is returned to water discharge 32 through a low pressure hydrogen separator 48. The low pressure hydrogen separator 48 allows hydrogen to separate from the water stream due to the reduced pressure, and also recycles water to water discharge 32 at lower pressures than the water exiting the separator 44. A desiccator chamber (not shown) may be provided in addition to or instead of diffuser 46.

Dry hydrogen from diffuser 46 is fed to a hydrogen storage receptacle 54. Valves 56, 58 may be provided at various points on the system lines, and may be configured to release hydrogen to vent 52 under certain conditions. Furthermore, a check valve 60 is provided to prevent the potential backflow of hydrogen to the diffuser 46 and separator 44. Additionally, a ventilation system 62 can be provided to assist in venting system gases when desired.

A hydrogen output sensor 64 can be incorporated into system 30 at a control 66. Hydrogen output sensor 64 can be any suitable output sensor, including but not limited to a flow rate sensor, a mass flow sensor, or any other quantitative or sensing device. For example, hydrogen output sensor 64 can be a pressure transducer, or the like, that converts the gas pressure within the hydrogen line to a voltage or current value for measurement. Hydrogen output sensor 64 is interfaced with the control 66, which is capable of converting the sensor reading (e.g., voltage or current value) into a pressure reading. Furthermore, a display (not shown) may be disposed in operable communication with the hydrogen output sensor 64 to provide a reading of the pressure, for example, at the location of hydrogen output sensor 64 on the hydrogen line. The control 66 can be any suitable gas output controller, such as an analog circuit, a digital microprocessor, or the like.

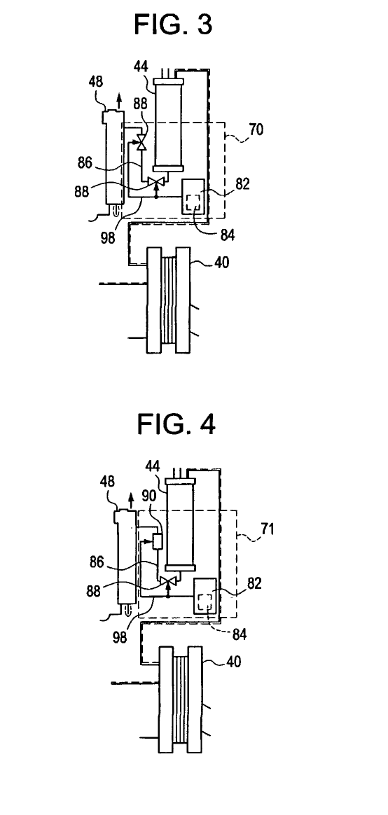

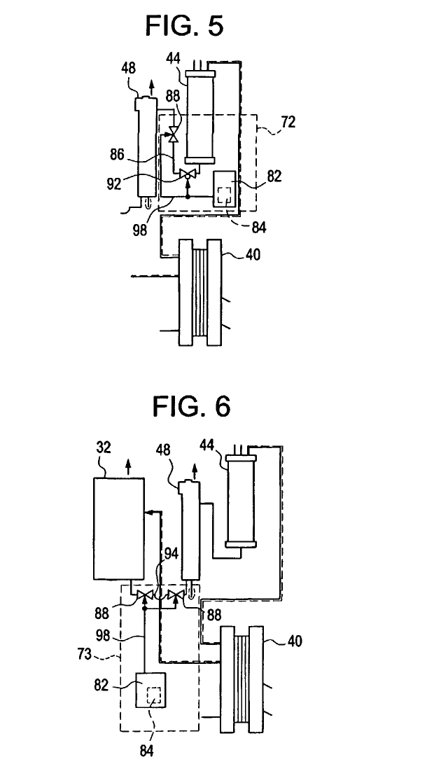

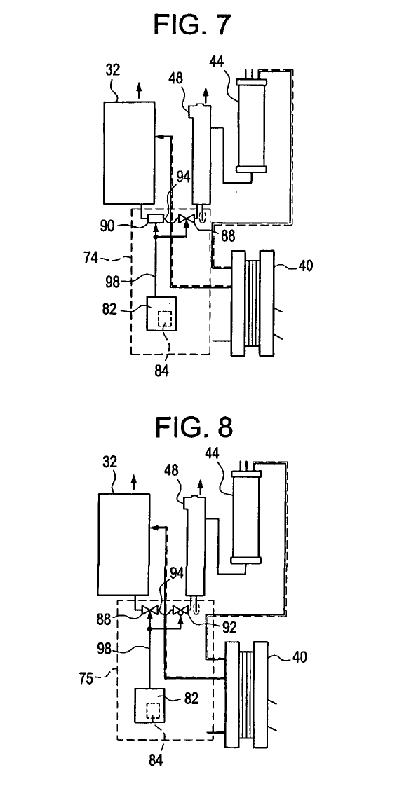

When operating system 30, the pressure accumulating within system 30 is monitored. If the pressure increases beyond a predetermined pressure limit, the system lines directing the flow of a liquid, e.g., reactant water, could become inoperable, thus disrupting the entire system. To monitor the pressure of a liquid, such as reactant water, within the system 30, and to reduce and/or eliminate the likelihood of pressure swings, (i.e., a sudden decrease below or increase above a predetermined pressure value), a pressure regulating system (see the various embodiments represented by 70-75 in FIGS. 3-9) can be included to control the pressure within the system 30. The pressure regulating system can comprise two or more flow control devices (e.g., a first flow control device and a second flow control device) serially disposed in fluid communication between the separator 44 and water discharge 32 for controlling the pressure (See generally FIG. 3). More particularly, the separator 44, first flow control device, second flow control device, and water discharge 32 are disposed in sequential order and in fluid communication with each other (See generally FIG. 6). Optionally, the first and second flow control devices are serially disposed in fluid communication between separator 44 and the hydrogen separator 48 and/or between the hydrogen separator 48 and the water discharge 32 (See FIGS. 3-8).

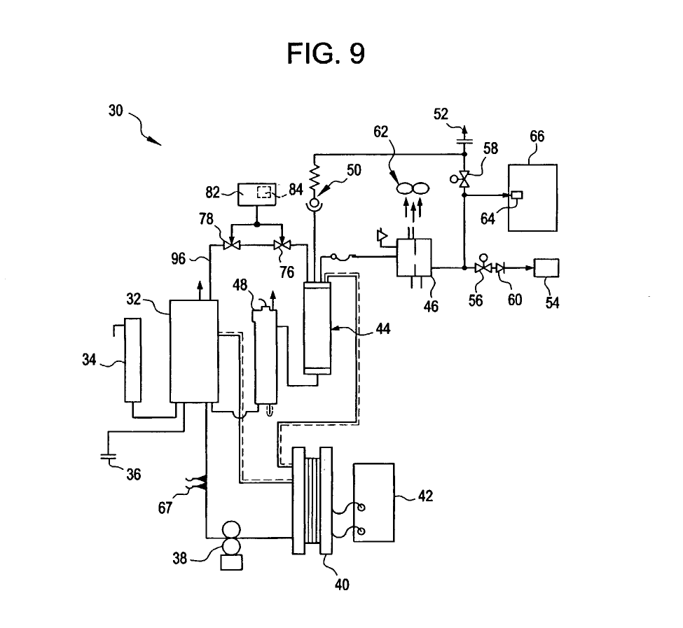

The first and second flow control devices comprise valve(s) (such as solenoid valves, proportional control valves, and/or the like), regulator(s) (e.g., temperature regulator(s), flow regulator(s), and/or the like), dome loaded pressure regulators, and combinations comprising at least one of the foregoing. For example, the flow control devices can comprise a pair of valves, e.g., a pair of solenoid valves, or a solenoid valve 88 and a proportional control valve 90, or a dome loaded pressure regulator 92 and a solenoid valve 88, disposed in the liquid outlet stream 86 (See FIGS. 3-5), or liquid outlet stream 94 (See FIGS. 6-8) and/or liquid outlet stream 96 (See FIG. 9); with each liquid outlet stream originating from separator 44.

In other words, the first and second flow control devices may be disposed in fluid communication between the separator 44 and the hydrogen separator 48 with a third and optionally fourth flow control device disposed between the hydrogen separator 48 and the water discharge.

The first and second flow control devices (e.g., 88, 90, 92) are disposed in operable communication with a control device 82 via a transmission connection 98. The control device 82 can adjust or regulate the liquid pressure within the system lines of system 30, e.g., the pressure of the liquid outlet stream 86, in response to a measure of the liquid pressure within system 30. The transmission connection 98 comprises any electronic medium suitable for transmitting data, signals, feedback, and the like, to and from control device 82 and the flow control devices, and optionally other system components (e.g., separator 44, hydrogen separator 48, and the like).

The control device 82 can transmit signals to actuate the first and/or second flow control devices, and receive signals from sensors (not shown) disposed throughout the system 30. The sensors can be serially disposed in operable communication between the separator 44 and the flow control devices, and/or between the flow control devices and water discharge 32. When hydrogen separator 48 is included, the sensors may also be serially disposed in operable communication between the hydrogen separator 48 and the separator 44, between the hydrogen separator 48 and the flow control devices, and/or between the hydrogen separator 48 and water discharge 32. In addition, a sensor can be optionally disposed in operable communication with each component of system 30, such as within each flow control device, control device 82, separator 44, hydrogen separator 48, water discharge 32, and the like. The sensors include, but are not limited to, pressure sensors, output sensors, flow rate sensors, mass flow sensors, and combinations comprising at least one of the foregoing sensors.

More particularly, the control device 82 may include a pressure sensor 84 (See generally FIGS. 3-8). The pressure sensor 84 can be a pressure transducer that converts a liquid pressure reading measured by a sensor in a system line, or in a component of system 30, to a measurable value (e.g. a voltage or current value) for measurement. The pressure sensor 84 interfaces with a control (not shown in the control device 82) that is capable of converting the measurable value into a pressure reading. The control may be any suitable fluid output controller, such as an analog circuit, a digital microprocessor, or the like. Alternatively, pressure sensor 84 can receive a pulse width modulated control signal from a sensor in the first and/or second flow control devices, which in turn, is used to calculate the pressure of the liquid within system 30. Furthermore, a display (not shown) may be disposed in operable communication with control device 82 to provide a reading of the liquid pressure within system 30.

The pressure readings are evaluated by the control device 82, such that when the liquid pressure exceeds a selected pressure value the first flow control device and/or second flow control device actuate to release liquid and lower the pressure. The liquid pressure can be lowered by actuating one or both of the first and second flow control devices at once or sequentially. The control device 82 can determine which flow control device(s) to actuate, when to actuate the flow control device(s), and how often to actuate the flow control device(s) based upon the liquid pressure readings.

As the liquid is released from system 30, control device 82 also maintains the pressure within system 30 so that a pressure swing does not occur in response to regulating the pressure. For example, the control device 82 can maintain the pressure by gradually increasing the liquid flow entering the separator 44 while releasing excess liquid to regulate the pressure, and then gradually decreasing the liquid flow as the pressure reaches the system's selected pressure level. Alternatively, a metering valve is employed.

For example, as liquid exits the separator 44 a pressure swing, e.g., a pressure build up, may occur in the liquid outlet stream 86. The sensors at separator 44, first flow control device, and optionally serially disposed between the two components, monitor the pressure readings, detect pressure build up, and signal the control device 82. The control device 82 determines the amount of pressure and compares that value to the predetermined pressure level for optimum performance of system 30. The control device 82 then calculates how much liquid to release in order to achieve the desired selected pressure level. In response to this calculation, the control device 82 actuates the first and/or second flow control devices to release the liquid, to eliminate the pressure swing by regulating the liquid pressure, and to maintain the liquid pressure within the entire system 30.

One embodiment of the pressure regulating system for a hydrogen gas generator, comprises: means for sensing a liquid level within a phase separation apparatus; means for regulating the liquid level within the phase separation apparatus; means for releasing liquid from the phase separation apparatus; and means for maintaining the pressure in the system within a selected range upon release of liquid from the phase separation apparatus.

One method for regulating pressure in an electrolysis cell system, comprises: sensing a liquid level within a hydrogen/water phase separation apparatus; regulating the liquid level within the phase separation apparatus by releasing liquid from the phase separation apparatus based upon the liquid level; and maintaining the pressure in the system within a selected range. Optionally, flow control valves disposed between a phase separation apparatus, a water discharge, and a low pressure hydrogen separator (or any combination thereof), can be controlled to adjust the liquid level in the phase separation apparatus, thereby controlling the pressure of the system. Preferably, the phase separation apparatus is disposed in an open fluid communication with an electrolysis cell stack, i.e., the hydrogen/water stream exiting the electrolysis cell stack is introduced to the phase separation apparatus at about the same pressure as it exited the stack (e.g., the pressure was not actively reduced, e.g., by valves).

The disclosed method can be embodied in the form of computer or controller implemented processes and apparatuses for practicing those processes. It can also be embodied in the form of computer program code containing instructions embodied in tangible media 70, such as floppy diskettes, CD-ROMs, hard drives, or any other computer-readable storage medium, wherein, when the computer program code is loaded into and executed by a computer or controller, the computer becomes an apparatus for practicing the method. The method may also be embodied in the form of computer program code or signal 72, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the method. When implemented on a general-purpose microprocessor, the computer program code segments configure the microprocessor to create specific logic circuits.

The pressure regulating system possesses several advantages such as adaptability, scalability, efficiently monitoring and regulating pressure swings, and enhancing the overall performance of an electrolysis system. The combination of flow control devices and sensors is suitable for regulating the pressure throughout an electrolysis system because any type of valve, or combination of valves, can be employed. In addition, the valves can be disposed alone or in combination where there exists the likelihood that a pressure swing may occur. Furthermore, the pressure regulating system can be scaled, i.e., the amount of valves and/or sensors employed can be increased or decreased, to accommodate the size of the system. Likewise, the valves and/or sensors can be selected based upon their compatibility with the system's components.

The pressure regulating system also enhances the overall performance of the system. For example, pressure swings can impact the accuracy of the system's instrumentation, and/or the operation of the system itself. The combination of flow control devices and sensors, positioned where pressure swings occur, can reduce and/or eliminate the likelihood that pressure swings will go undetected or unregulated, thus enhancing the overall performance of the system.

Namely this system, provides open fluid communication (e.g., no pressure control device (beside a possible relief valve or safety type mechanism) between the electrolysis cell stack and the phase separation apparatus), and disposes flow control devices between the phase separation device and the water discharge, with an optional low pressure hydrogen separator disposed therebetween.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

1. An electrochemical cell system, comprising:
an electrochemical cell stack;
a phase separation apparatus in fluid communication with the electrochemical cell stack;
a water discharge in fluid communication with the phase separation apparatus;
a first flow control device and a second flow control device disposed in fluid communication between the phase separation apparatus and water discharge; and
a control device in operable communication with a sensor, the first flow control device, and the second flow control device.

2. The electrochemical cell system of claim 1, further comprising a hydrogen separator, wherein the first flow control device and the second flow control device are disposed in fluid communication between the phase separation apparatus and the hydrogen separator.

3. The electrochemical cell system of claim 2, wherein the sensor is disposed in operable communication with the hydrogen separator.

4. The electrochemical cell system of claim 2, wherein the sensor is disposed in operable communication between the hydrogen separator and the phase separation apparatus.

5. The electrochemical cell system of claim 2, wherein the sensor is disposed in operable communication between the hydrogen separator and the first flow control device.

6. The electrochemical cell system of claim 1, wherein the sensor is disposed in fluid communication between the hydrogen separator and the water discharge.

7. The electrochemical cell system of claim 6, wherein the sensor is disposed in operable communication between the second flow control device and hydrogen separator.

8. The electrolysis cell system of claim 1, wherein the control device initiates actuation of at least one of the flow control device and the second flow control device if a pressure signal from the sensor is above a first selected amount or below a second selected amount.

9. The electrochemical cell system of claim 1, wherein the sensor is selected from the group consisting of a pressure sensor, an output sensor, a flow rate sensor, a mass flow sensor, and combinations comprising at least one of the foregoing sensors.

10. The electrochemical cell system of claim 1, wherein the first flow control device and the second flow control device comprise valves.

11. The electrochemical cell system of claim 1, wherein the sensor is disposed in operable communication between the phase separation apparatus and the first flow control device, and further comprising a additional sensors disposed in operable communication between the first flow control device and the second flow control device, and between the second flow control device and the water discharge, wherein the additional sensors are in operable communication with the control device.

12. The electrochemical cell system of claim 1, further comprising a third flow control device disposed in fluid communication between a hydrogen separator and the water discharge, wherein the third flow control device is in operable communication with the control device.

13. The electrochemical cell system of claim 12, further comprising a fourth flow control device disposed in fluid communication between the third flow control device and the water discharge, wherein the fourth flow control device is in operable communication with the control device.

14. A pressure regulating system for a hydrogen gas generator system, comprising:
means for generating hydrogen;
means for sensing a liquid level within a phase separation apparatus disposed in fluid communication with the means for generating hydrogen;
means for regulating the liquid level within the phase separation apparatus disposed in operable communication with the phase separation apparatus; and
means for maintaining a system pressure in the hydrogen gas generator system within a selected range upon release of liquid from the phase separation apparatus.

15. The pressure regulating system of claim 14, further comprising a means for receiving separated water disposed in fluid communication with the phase separation apparatus, wherein the means for maintaining the pressure regulating further comprises a first flow control device and a second flow control device disposed in operable communication with the phase separation apparatus, and between the phase separation apparatus and the means for receiving separated water.

16. The pressure regulating system of claim 15, further comprising a means for determining the system pressure disposed in operable communication with the hydrogen generating system, the means for maintaining the pressure.

17. A method for regulating pressure in an electrolysis cell system, comprising:
directing a fluid stream from an electrolysis cell to a hydrogen/water phase separation apparatus;
sensing a liquid level within the hydrogen/water phase separation apparatus;
regulating the liquid level within the hydrogen/water phase separation apparatus by at least one of introducing and releasing liquid from the hydrogen/water phase separation apparatus based upon the liquid level;
monitoring electrolysis cell system pressure;
regulating electrolysis cell system pressure with a first flow control device and a second flow control device disposed in fluid communication between the hydrogen/water phase separation apparatus and a water discharge, and in operable communication with a control device; and
maintaining the electrolysis cell system pressure within a selected range.

18. The method of claim 17, wherein maintaining the electrolysis cell system pressure further comprises at least one of opening the first flow control valve, opening the second flow control valve.

19. The method of claim 17, wherein the first flow control valve and the second flow control valve are opened sequentially.

20. A computer data signal, comprising:
instructions for causing a computer to implement a method for operating a power system, the method comprising:
sensing a liquid level within a hydrogen/water phase separation apparatus;
regulating the liquid level within the hydrogen/water phase separation apparatus by at least one of introducing and releasing liquid from the hydrogen/water phase separation apparatus based upon the liquid level;
monitoring electrolysis cell system pressure;
regulating electrolysis cell system pressure with a first flow control device and a second flow control device disposed in fluid communication between the hydrogen/water phase separation apparatus and a water discharge, and in operable communication with a control device; and
maintaining the electrolysis cell system pressure within a selected range.
